(19) United States
(12) Patent Application Publication
(10) Pub. No.: US 2026/0142553 A1
(43) Pub. Date: May 21, 2026

(54) LIQUID CRYSTAL LIGHT CONTROLLER DRIVING POWER SUPPLY

(71) Applicant: KABUSHIKI KAISHA TOYOTA JIDOSHOKKI, Aichi (JP)

(72) Inventors: Mika FUJII, Kariya-shi (JP); Hironobu FURUYA, Kariya-shi (JP)

(73) Assignee: KABUSHIKI KAISHA TOYOTA JIDOSHOKKI, Aichi (JP)

(21) Appl. No.: 19/391,286

(22) Filed: Nov. 17, 2025

(30) Foreign Application Priority Data
Nov. 21, 2024 (JP) 2024-203087

(51) Int. Cl. H02M 1/00; B60J 3/04; H02M 3/335; H02M 7/5387

(52) U.S. Cl. CPC H02M 1/007; B60J 3/04; H02M 3/33571; H02M 7/53871

(57) ABSTRACT

A liquid crystal light controller driving power supply configured to change a haze ratio of a liquid crystal layer in a liquid crystal light controller includes a DC/DC circuit section configured to receive a DC input voltage and provide a DC output voltage and a DC/AC circuit section configured to convert the DC output voltage from the DC/DC circuit section to an AC voltage and output the converted AC voltage to the liquid crystal light controller. The DC/AC circuit section includes an inverter circuit that converts the DC output voltage from the DC/DC circuit section to the AC voltage having a modified sine waveform by switching operation of a switching element and an output control unit that changes a voltage value of the AC voltage by controlling an ON-time of the switching element.

### CROSS-REFERENCE OF THE RELATED APPLICATION

This application claims priority to Japanese Patent Application No. 2024-203087 filed on Nov. 21, 2024, the entire disclosure of which is incorporated herein by reference.

### BACKGROUND ART

The present disclosure relates to a liquid crystal light controller driving power supply.

A liquid crystal light controller driving power supply disclosed in Japanese Patent Application Publication No. 2022-120350 includes a DC/DC converter, a peak voltage generating unit, and a DC/AC inverter. The DC/DC converter receives an DC input voltage and provide a DC output voltage having a first voltage value. The peak voltage generating unit generates a plurality of DC voltages having different voltage values from the DC voltage output from the DC/DC converter. The DC/AC inverter converts a DC voltage output from the peak voltage generating unit to an AC voltage and outputs the converted AC voltage to a liquid crystal light controller. The liquid crystal light controller changes in a haze ratio depending on a voltage value of the AC voltage.

In the Publication, it is impossible to change the haze ratio of the liquid crystal light controller little by little.

### SUMMARY

In accordance with an aspect of the present disclosure, there is provided a liquid crystal light controller driving power supply configured to change a haze ratio of a liquid crystal layer in a liquid crystal light controller by supplying power to the liquid crystal light controller, the liquid crystal light controller driving power supply that includes a DC/DC circuit section configured to receive a DC input voltage and provide a DC output voltage having a different voltage value and a DC/AC circuit section configured to convert the DC output voltage from the DC/DC circuit section to an AC voltage and output the converted AC voltage to the liquid crystal light controller. The DC/AC circuit section includes an inverter circuit that converts the DC output voltage from the DC/DC circuit section to the AC voltage having a modified sine waveform by switching operation of a switching element and an output control unit that changes a voltage value of the AC voltage by controlling an ON-time of the switching element.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a circuit diagram of a liquid crystal light controller driving power supply;

FIG. 2 is a figure illustrating an example of a modified sine wave output from a DC/AC circuit section; and

FIG. 3 is a graph showing a corresponding relationship between an AC voltage and a haze ratio of a liquid crystal light controller.

### DETAILED DESCRIPTION OF THE EMBODIMENTS

The following will describe an embodiment of a liquid crystal light controller driving power supply according to the present disclosure.

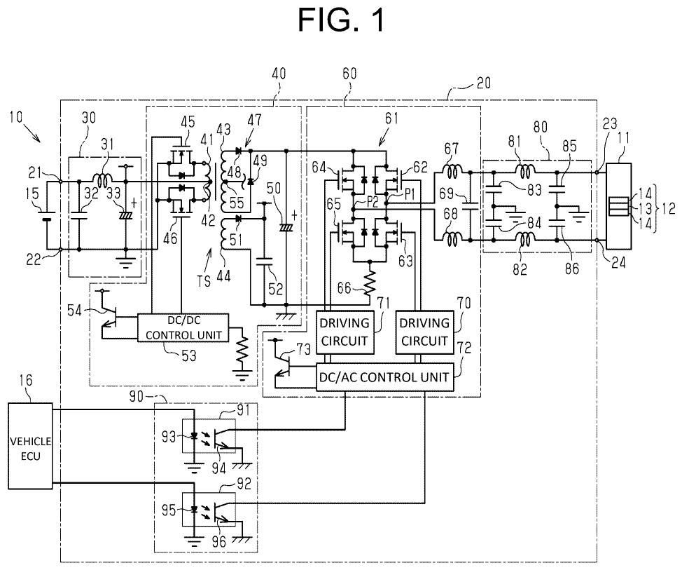

As illustrated in FIG. 1, a vehicle 10 includes a liquid crystal light controller 11, a battery 15, and a vehicle ECU 16.

The liquid crystal light controller 11 is used as a light control glass that is disposed in, for example, a side window or a sunroof. The liquid crystal light controller 11 is formed, for example, by holding a liquid crystal film 12 between two glasses. The liquid crystal film 12 includes a liquid crystal layer 13 and coating layers 14 provided on opposites sides of the liquid crystal layer 13. The coating layers 14 are made of, for example, indium tin oxide (ITO). The liquid crystal layer 13 contains liquid crystal molecules. Orientation of the liquid crystal molecules changes in response to a voltage applied to the liquid crystal layer 13 through the coating layers 14, which leads to a change in a haze ratio of the liquid crystal layer 13.

The battery 15 is a power source for electrical components in the vehicle 10. The battery 15 is, for example, a secondary battery such as a lead storage battery or a lithium ion secondary battery.

The vehicle ECU (Electronic Control Unit) 16 outputs commands in response to user operations. The user is a passenger in the vehicle 10.

The vehicle 10 includes a liquid crystal light controller driving power supply 20. The liquid crystal light controller driving power supply 20 is provided between the battery 15 and the liquid crystal light controller 11. The liquid crystal light controller driving power supply 20 converts a DC voltage output from the battery 15 to an AC voltage and outputs the converted AC voltage to the liquid crystal light controller 11, thereby supplying a power to the liquid crystal light controller 11.

The liquid crystal light controller driving power supply 20 includes a first input terminal 21 and a second input terminal 22. The first input terminal 21 is electrically connected to a positive electrode of the battery 15. The second input terminal 22 is electrically connected to a negative electrode of the battery 15.

The liquid crystal light controller driving power supply 20 includes an input filter 30. The input filter 30 includes a coil 31, a capacitor 32, and an electrolytic capacitor 33. The coil 31 is connected to the first input terminal 21. The capacitor 32 and the electrolytic capacitor 33 are connected in parallel to each other between the first input terminal 21 and the second input terminal 22.

The liquid crystal light controller driving power supply 20 includes a DC/DC circuit section 40. The DC/DC circuit section 40 receives the DC input voltage from the battery 15 through the input filter 30 and provides a DC output voltage having a different voltage value. The DC/DC circuit section 40 includes a transformer TS, a first switching element 45, a second switching element 46, a rectifying circuit 47, an electrolytic capacitor 50, a diode 51, a capacitor 52, a DC/DC control unit 53, and a switch 54.

The transformer TS includes a primary coil 41 and secondary coils 43 and 44. The primary coil 41 has a center tap 42. A first terminal of the primary coil 41 is connected to the first switching element 45. A second terminal of the primary coil 41 is connected to the second switching element 46. The center tap 42 is connected to the coil 31.

The rectifying circuit 47 includes a first diode 48 and a second diode 49. An anode of the first diode 48 is connected to a first terminal of the secondary coil 43. An anode of the second diode 49 is connected to a second terminal of the secondary coil 43. A cathode of the first diode 48 and a cathode of the second diode 49 are connected to each other. The cathode of the first diode 48 and the cathode of the second diode 49 are electrically connected to a first terminal of the electrolytic capacitor 50. The anode of the first diode 48 and the anode of the second diode 49 are electrically connected to a second terminal of the electrolytic capacitor 50. The secondary coil 43 has a center tap 55 connected to the second terminal of the electrolytic capacitor 50, so that the anode of the first diode 48 and the anode of the second diode 49 are electrically connected to the second terminal of the electrolytic capacitor 50.

A first terminal of the secondary coil 44 is connected to an anode of the diode 51. A cathode of the diode 51 is connected to a first terminal of the capacitor 52. A second terminal of the secondary coil 44 is connected to a second terminal of the capacitor 52.

The DC/DC control unit 53 controls the first switching element 45 and the second switching element 46. The DC/DC control unit 53 is, for example, an IC (Integrated Circuit). The DC/DC control unit 53 is connected to a node between the coil 31 and the center tap 42 through the switch 54. The DC/DC control unit 53 is driven by the DC voltage output from the input filter 30.

The DC/DC control unit 53 alternately turns on the first switching element 45 and the second switching element 46. When the first switching element 45 is turned on, a current flows from the center tap 42 toward the first terminal of the primary coil 41. When the second switching element 46 is turned on, a current flows from the center tap 42 toward the second terminal of the primary coil 41.

When the current flows through the primary coil 41, a voltage is induced in each of the secondary coils 43 and 44. The voltage induced in the secondary coil 43 is rectified by the rectifying circuit 47. As a result, a DC voltage is output from the rectifying circuit 47. The voltage induced in the secondary coil 44 is rectified by the diode 51. As a result, a DC voltage is output from the diode 51.

The liquid crystal light controller driving power supply 20 includes a DC/AC circuit section 60. The DC/AC circuit section 60 converts the DC voltage output from the DC/DC circuit section 40 into an AC voltage and outputs the converted AC voltage to the liquid crystal light controller 11. The DC/AC circuit section 60 includes an inverter circuit 61, a resistor 66, coils 67 and 68, a capacitor 69, driving circuits 70 and 71, a DC/AC control unit 72, and a switch 73.

The inverter circuit 61 includes four switching elements 62 to 65. The inverter circuit 61 has a full-bridge configuration formed of four switching elements 62 to 65. The four switching elements 62 to 65 include a first high side switching element 62, a first low side switching element 63, a second high side switching element 64, and a second low side switching element 65. The first high side switching element 62 and the first low side switching element 63 are connected in series to each other. The second high side switching element 64 and the second low side switching element 65 are connected in series to each other. The first terminal of the electrolytic capacitor 50 is connected to the high side switching elements 62 and 64. The second terminal of the electrolytic capacitor 50 is connected to the low side switching elements 63 and 65 through the resistor 66. The inverter circuit 61 converts the DC voltage output from the DC/DC circuit section 40 to an AC voltage by switching operation of the switch elements 62 to 65.

The coil 67 is connected to a first node P1 at which the first high side switching element 62 and the first low side switching element 63 are connected to each other. The coil 68 is connected to a second node P2 at which the second high side switching element 64 and the second low side switching element 65 are connected to each other. The capacitor 69 is connected to the two coils 67 and 68.

The DC/AC control unit 72 controls the switching elements 62 to 65 by outputting control signals to the driving circuits 70 and 71. The DC/AC control unit 72 is, for example, a microcontroller. The DC/AC control unit 72 is connected to the cathode of the diode 51 through the switch 73. The DC/AC control unit 72 is driven by the voltage rectified by the diode 51.

The driving circuit 70 switches the first high side switching element 62 and the first low side switching element 63 on and off in response to the control signals from the DC/AC control unit 72. When turning on the first high side switching element 62, the driving circuit 70 turns off the first low side switching element 63. When turning off the first high side switching element 62, the driving circuit 70 turns on the first low side switching element 63.

The driving circuit 71 switches the second high side switching element 64 and the second low side switching element 65 on and off in response to the control signals from the DC/AC control unit 72. When turning on the second high side switching element 64, the driving circuit 71 turns off the second low side switching element 65. When turning off the second high side switching element 64, the driving circuit 71 turns on the second low side switching element 65.

The DC/AC control unit 72 controls the first high side switching element 62 and the second low side switching element 65 so that they are simultaneously turned on. Here, an electric potential at the first node P1 is greater than an electric potential of the second node P2, so that a positive voltage is generated between the first node P1 and the second node P2.

The DC/AC control unit 72 controls the second high side switching element 64 and the first low side switching element 63 so that they are simultaneously turned on. Here, the electric potential at the first node P1 is less than the electric potential at the second node P2, so that a negative voltage is generated between the first node P1 and the second node P2. Thus, the DC/AC control unit 72 converts a DC voltage to an AC voltage.

The liquid crystal light controller driving power supply 20 includes an output filter 80. The output filter 80 includes two coils 81 and 82 and four capacitors 83 to 86. The coil 81 is connected to the coil 67. The coil 82 is connected to the coil 68. The two coils 81 and 82 forms a common mode choke coil, for example.

The two capacitors 83 and 84 are connected in series to each other between a first terminal of the coil 81 and a first terminal of the coil 82. A node between the two capacitors 83 and 84 is grounded. The two capacitors 85 and 86 are connected in series to each other between a second terminal of the coil 81 and a second terminal of the coil 82. A node between the two capacitors 85 and 86 is grounded.

The liquid crystal light controller driving power supply 20 includes a first output terminal 23 and a second output terminal 24. The first output terminal 23 is connected to the coil 81. The second output terminal 24 is connected to the coil 82. The two output terminals 23 and 24 are connected to the liquid crystal light controller 11. Noise in the AC voltage output from the DC/AC circuit section 60 is reduced by the output filter 80. Then, the AC voltage in which the noise is reduced by the output filter 80 is applied to the liquid crystal light controller 11 through the two output terminals 23 and 24. This changes the haze ratio of the liquid crystal layer 13.

The liquid crystal light controller driving power supply 20 includes a communication circuit 90 that communicates with the vehicle 10. The communication circuit 90 includes two opt-isolators 91 and 92. The opt-isolator 91 includes a photodiode 93 and a phototransistor 94. The opt-isolator 92 includes a photodiode 95 and a phototransistor 96. The photodiodes 93 and 95 are connected to the vehicle ECU 16. The phototransistors 94 and 96 are connected to the DC/AC control unit 72. When the phototransistor 94 receives light emitted from the photodiode 93, the phototransistor 94 turns on. When the phototransistor 96 receives light emitted from the photodiode 95, the phototransistor 96 turns on. The opt-isolators 91 and 92 may be replaced with insulating elements such as isolators.

### Control by DC/AC Control Unit

The DC/AC control unit 72 changes an ON-time of each of the switching elements 62 to 65 to allow the AC voltage having a desired value to be output from the DC/AC circuit section 60. The DC/AC control unit 72 is an output control unit.

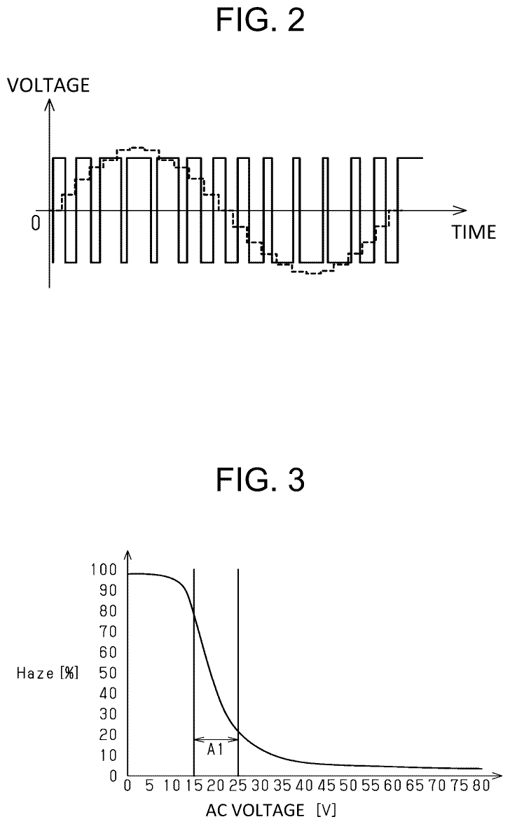

FIG. 2 is a schematic figure illustrating the AC voltage output from the DC/AC circuit section 60 and the voltage generated between the two nodes P1 and P2, wherein the former voltage is indicated by a broken line and the later voltage is indicated by a solid line. As illustrated in FIG. 2, the AC voltage output from the DC/AC circuit section 60 changes in accordance with the voltage generated between the two nodes P1 and P2. The AC voltage is an average voltage obtained by averaging the voltage generated between the two nodes P1 and P2 at predetermined time intervals. Accordingly, when a width of the voltage generated between the two nodes P1 and P2, that is, a period of time when the positive voltage is generated and a period of time when the negative voltage is generated are changed, the AC voltage changes. Furthermore, the AC voltage also changes in accordance with on a period of time when no voltage is generated between the two nodes P1 and P2. The width of the positive voltage changes in accordance with the ON-time of the first high side switching element 62 and the second low side switching element 65. The width of the negative voltage changes in accordance with the ON-time of the second high side switching element 64 and the first low side switching element 63. The period of time when no voltage is generated between the two nodes P1 and P2 changes in accordance with an OFF-time of each of the four switching elements 62 to 65. Thus, the AC voltage may be changed to a desired value by a pulse width modulation (PWM) control on the four switching elements 62 to 65.

The AC voltage output from the DC/AC circuit section 60 has a modified sine waveform. A modified sine wave has a waveform in which the voltage alternates between the positive value and the negative value in one cycle and the voltage value changes linearly in at least a part of the one cycle. There is a plurality of control cycles of the PWM control in the half cycle of the modified sine wave. That is, the switching elements 62 to 65 are switched on and off multiple times in the half cycle of the modified sine wave. Thus, the voltage generated between the two nodes P1 and P2 is changed multiple times so that the voltage alternates between the positive value and the negative value or the voltage becomes 0 [V] in the half cycle of the modified sine wave by the switching of the switching elements 62 to 65 on and off.

The DC/AC control unit 72 may switch the liquid crystal layer 13 between a transparent state and an opaque state by controlling the AC voltage output from the DC/AC circuit section 60. A user can switch the liquid crystal layer 13 between the transparent state and the opaque state. Furthermore, the user can select a switching mode in which the liquid crystal layer 13 is switched between the transparent state and the opaque state. The switching mode includes a normal mode and a slow change mode.

For example, the vehicle 10 has an operating unit that is operable by the user. The user operates the operating unit to select a state of the liquid crystal layer 13 from the transparent state and the opaque state. Furthermore, the user operates the operation unit to select the switching mode from the normal mode and the slow change mode.

In accordance with the state of the liquid crystal layer 13 selected from the transparent state and the opaque state by the user, the vehicle ECU 16 switches a signal that is output from the vehicle ECU 16 to the opt-isolator 91 between a high-level signal or a low-level signal. When the high-level signal is output to the opt-isolator 91, the photodiode 93 emits light to turn on the phototransistor 94. When the phototransistor 94 is turned on, a high-level signal is input to the DC/AC control unit 72. As described above, a signal input from the opt-isolator 91 to the DC/AC control unit 72 is switched between a high-level signal and a low-level signal.

In accordance with the mode selected from the normal mode and the slow change mode, the vehicle ECU 16 switches the signal output from the vehicle ECU 16 to the opt-isolator 92 between a high-level signal and a low-level signal. When the high-level signal is output to the opt-isolator 92, the photodiode 95 emits light to turn on the phototransistor 96. When the phototransistor 96 is turned on, a high-level signal is input to the DC/AC control unit 72. As described above, a signal input from the opt-isolator 92 to the DC/AC control unit 72 is switched between a high-level signal and a low-level signal.

The DC/AC control unit 72 performs control in accordance with a combination of the signal input from the opt-isolator 91 and the signal input from the opt-isolator 92.

As illustrated in FIG. 3, the haze ratio of the liquid crystal layer 13 changes depending on a voltage value of the AC voltage that is applied to the liquid crystal light controller 11. The voltage value of the AC voltage is a root mean square (RMS) value. In the following description, the voltage value indicates an RMS value of an AC voltage. The haze ratio indicates haze (haze value) and is defined as a ratio of diffuse transmittance [%] to total transmittance [%]. The method of calculating the haze is defined by JIS K 7136 or ISO 14782, for example.

The haze ratio is decreased as the voltage that is applied to the liquid crystal light controller 11 is increased. Thus, the liquid crystal layer 13 is switched between the transparent state and the opaque state. The transparent state of the liquid crystal layer 13 is, for example, a state in which the haze ratio of the liquid crystal layer 13 is less than a first predetermined value. The first predetermined value is, for example, within a range from 10 [%] to 15 [%]. The opaque state of the liquid crystal layer 13 is, for example, a state in which the haze ratio of the liquid crystal layer 13 is greater than a second predetermined value. The second predetermined value is, for example, within a range from 85 [%] to 90 [%]. When the haze ratio of the liquid crystal layer 13 is changed, a perception range A1 in which people easily perceive the change in the haze ratio of the liquid crystal layer 13 is, for example, from 20 [%] to 80 [%].

When the phototransistor 94 of the opt-isolator 91 is turned off and the low-level signal is input to the DC/AC control unit 72, that is, the liquid crystal layer 13 is switched from the transparent state to the opaque state, the DC/AC control unit 72 stops applying the AC voltage to the liquid crystal light controller 11. When the liquid crystal layer 13 is switched from the opaque state to the transparent state, the DC/AC control unit 72 applies the AC voltage to the liquid crystal light controller 11.

### Normal Mode

In a case where the normal mode is selected by the user, that is, in a case where the phototransistor 96 of the opt-isolator 92 is turned on and the high-level signal is input to the DC/AC control unit 72, the DC/AC control unit 72 switches the liquid crystal layer 13 between the transparent state and the opaque state by controlling whether the AC voltage is applied to the liquid crystal light controller 11 or not.

When switching the liquid crystal layer 13 from the transparent state to the opaque state, the DC/AC control unit 72 sets a target value of the AC voltage that is applied to the liquid crystal light controller 11 to 0 [V]. That is, when switching the liquid crystal layer 13 from the transparent state to the opaque state, the DC/AC control unit 72 performs control such that the DC/AC control unit 72 immediately stops applying the AC voltage to the liquid crystal light controller 11 in a state in which the AC voltage is applied to the liquid crystal light controller 11.

When switching the liquid crystal layer 13 from the opaque state to the transparent state, the DC/AC control unit 72 sets the target value of the AC voltage that is applied to the liquid crystal light controller 11 to a voltage value corresponding to the transparent state. That is, when switching the liquid crystal layer 13 from the opaque state to the transparent state, the DC/AC control unit 72 performs control such that the AC voltage having the voltage value corresponding to the transparent state is immediately applied to the liquid crystal light controller 11 in a state in which the AC voltage is not applied to the liquid crystal light controller 11.

### Slow Change Mode

In a case where the slow change mode is selected by the user, that is, in a case where the phototransistor 96 of the opt-isolator 92 is turned off and the low-level signal is input to the DC/AC control unit 72, the DC/AC control unit 72 changes a voltage value of the AC voltage that is applied to the liquid crystal light controller 11 little by little.

When switching the liquid crystal layer 13 from the transparent state to the opaque state, the DC/AC control unit 72 decreases the target value of the AC voltage that is applied to the liquid crystal light controller 11 to 0 [V] step by step. That is, a rate of decreasing the voltage value in the slow change mode is smaller than that in the normal mode. Since it takes a long time to stop applying the AC voltage, it also takes a long time for the liquid crystal layer 13 to switch from the transparent state to the opaque state.

When switching the liquid crystal layer 13 from the opaque state to the transparent state, the DC/AC control unit 72 increases the target value of the AC voltage that is applied to the liquid crystal light controller 11 from 0 [V] step by step. That is, a rate of increasing the voltage value in the slow change mode is smaller than that in the normal mode. Since it takes a long time to set the voltage value to the value corresponding to the transparent state, it also takes a long time for the liquid crystal layer 13 to switch from the opaque state to the transparent state.

In addition, in the present embodiment, the DC/AC control unit 72 makes a rate of the change in the voltage value smaller in the perception range A1 than in a range outside the perception range A1. The rate of change of the voltage value includes at least one of the rate of decreasing in the voltage value and the rate of increasing of the voltage value. In the present embodiment, when the voltage value is 15 [V], the haze ratio is 80 [%]. When the voltage value is 25 [V], the haze ratio is 20 [%]. Accordingly, in the present embodiment, a voltage value corresponding to the perception range A1 is equal to or greater than 15 [V] and equal to or less than 25 [V]. The voltage value corresponding to the perception range A1 may vary depending on a type of the liquid crystal light controllers 11. That is, in the present embodiment, the voltage value corresponding to the perception range A1 is set to be equal to or greater than a voltage value at which the haze ratio is 80 [%] and equal to or less than a voltage value at which the haze ratio is 20 [%].

When switching the liquid crystal layer 13 from the transparent state to the opaque state, the DC/AC control unit 72 decreases the target value of the AC voltage at a first decreasing rate in a state in which the voltage value is greater than 25 [V]. When the voltage value is decreased from a voltage value greater than 25 [V] to reach 25 [V], the DC/AC control unit 72 decreases the target value of the AC voltage at a second decreasing rate. When the voltage value becomes less than 15 [V], the DC/AC control unit 72 decreases the target value of the AC voltage at a third decreasing rate. The second decreasing rate is smaller than each of the first decreasing rate and the third decreasing rate. For example, when the DC/AC control unit 72 decreases the target value of the AC voltage at the predetermined time intervals, an amount of decreasing the target value in a range from 15 [V] to 25 [V] is smaller than in other ranges. The first decreasing rate and the third decreasing rate may be equal to each other, or may be different from each other.

When switching the liquid crystal layer 13 from the opaque state to the transparent state, the DC/AC control unit 72 increases the target value of the AC voltage at a first increasing rate in a state in which the voltage value is less than 15 [V]. When the voltage value is increased from a voltage value less than 15 [V] to reach 15 [V], the DC/AC control unit 72 increases the target value of the AC voltage at a second increasing rate. When the voltage value becomes greater than 25 [V], the DC/AC control unit 72 increases the target value of the AC voltage at a third increasing rate. The second increasing rate is smaller than each of the first increasing rate and the third increasing rate. For example, when the DC/AC control unit 72 increases the target value of the AC voltage at the predetermined time intervals, an amount of increasing the target value is smaller in the range from 15 [V] to 25 [V] than in other ranges. The first increasing rate and the third increasing rate may be equal to each other and may be different from each other.

### Advantageous Effects of Present Embodiment

(1) The DC/AC control unit 72 may change the voltage value of the AC voltage that is output to the liquid crystal light controller 11 by performing the PWM control. The haze ratio of the liquid crystal layer 13 changes depending on the voltage value of the AC voltage that is applied to the liquid crystal light controller 11. Accordingly, the haze ratio of the liquid crystal layer 13 is changed by changing the voltage value of the AC voltage that is applied to the liquid crystal light controller 11. The haze ratio of the liquid crystal layer 13 is changed little by little by changing the voltage value step by step.
(2) The DC/AC control unit 72 makes the rate of the change in the voltage value smaller in the perception range A1 in which people easily perceive the change in the haze ratio of the liquid crystal layer 13, as compared with the range outside the perception range A1. This increases a switching rate at which the liquid crystal layer 13 is switched between the transparent state and the opaque state, while allowing the people to perceive the change in the haze ratio little by little.
(3) The liquid crystal light controller driving power supply 20 includes the communication circuit 90 that communicates with the vehicle ECU 16. With this configuration, the switching mode may be changed in response to the user operations.
(4) The DC/AC circuit section 60 outputs the modified sine wave. In a case where a square wave is output to the liquid crystal light controller 11, an inrush current flows due to a capacitance component of the liquid crystal light controller 11, which generates noise. In contrast, in the present embodiment, the modified sine wave is output to the liquid crystal light controller 11, so that the voltage is applied to the capacitance component of the liquid crystal light controller 11 little by little, as compared with a case where the square wave is output to the liquid crystal light controller 11. This suppresses that an inrush current flows, so that noise is suppressed.
(5) There is no need to provide a plurality of transformers for changing the voltage value of the voltage input from the battery 15. This reduces manufacturing costs of the liquid crystal light controller driving power supply 20, as compared with a case where the voltage value is changed by the plurality of the transformers.
(6) The DC/AC control unit 72 may set the voltage value of the AC voltage that is output to the liquid crystal light controller 11 to a desired value by performing the PWM control. With this control, the DC/AC control unit 72 may keep the liquid crystal layer 13 in a translucent state. The translucent state is a state between the transparent state and the opaque state. The DC/AC control unit 72 may set the liquid crystal layer 13 in the translucent state in response to commands from the vehicle ECU 16.

In addition, an upper limit of the voltage value of the AC voltage that is applicable to the liquid crystal light controller 11 may vary depending on a type of the liquid crystal light controllers 11. Since the voltage value may be set to a desired value by performing the PWM control, the voltage value may be controlled so as not to exceed the upper limit. With this control, the liquid crystal light controller driving power supply 20 handles a plurality of types of the liquid crystal light controllers 11.

### Modification

The embodiment may be modified as follows. The embodiment and the following modifications can be combined with each other as long as they do not technically contradict each other.

The liquid crystal light controller driving power supply 20 does not need to include the communication circuit 90. In this case, the DC/AC control unit 72 always switches the liquid crystal layer 13 between the transparent state and the opaque state in the slow change mode.

The communication circuit 90 may be a communication device that communicates with the vehicle ECU 16 under a vehicle communication protocol. The vehicle communication protocol is, for example, a controller area network (CAN) or a local interconnect network (LIN).

The DC/AC control unit 72 may change the voltage value at the same rate in the perception range A1 and the range outside the perception range A1.

The voltage value corresponding to the perception range A1 is not necessarily set to be equal to or greater than the voltage value at which the haze ratio is 80 [%] and equal to or less than a voltage value at which the haze ratio is 20 [%]. The voltage value corresponding to the perception range A1 may be set to be within a range of the voltage value at which the haze ratio is a desired value, such as equal or greater than a voltage value at which the haze ratio is 90 [%], equal to or less than a voltage value at which the haze ratio is 10 [%], equal or greater than a voltage value at which the haze ratio is 70 [%], or equal to or less than a voltage value at which the haze ratio is 30 [%].

The DC/AC control unit 72 may be an IC.

The opt-isolators 91 and 92 may be each connected to a switch. The switch is provided so as to be switched on and off in response to user operations. When a power supply is connected to the switch, an output signal is switched between a high-level and a low-level by switching the switch on and off. This provides the same advantageous effects as those in the embodiment. The wording of “communicates with the vehicle”, which is performed by the communication circuit 90, is not limited to the communication with the vehicle ECU 16 and may means that a member provided in the vehicle 10 receives the user operations.

The liquid crystal light controller 11 and the liquid crystal light controller driving power supply 20 do not need to be provided on the vehicle 10. For example, the liquid crystal light controller 11 may be used as a light control grass provided in a building.

What is claimed is:

1. A liquid crystal light controller driving power supply configured to change a haze ratio of a liquid crystal layer in a liquid crystal light controller by supplying power to the liquid crystal light controller, the liquid crystal light controller driving power supply comprising:
a DC/DC circuit section configured to receive a DC input voltage and provide a DC output voltage having a different voltage value; and
a DC/AC circuit section configured to convert the DC output voltage from the DC/DC circuit section to an AC voltage and output the converted AC voltage to the liquid crystal light controller, wherein
the DC/AC circuit section includes:
an inverter circuit that converts the DC output voltage from the DC/DC circuit section to the AC voltage having a modified sine waveform by switching operation of a switching element; and
an output control unit that changes a voltage value of the AC voltage by controlling an ON-time of the switching element.

2. The liquid crystal light controller driving power supply according to claim 1, wherein
the output control unit makes a rate of the change in the voltage value smaller in a perception range in which people easily perceive a change in the haze ratio of the liquid crystal layer, as compared with a range outside the perception range.

3. The liquid crystal light controller driving power supply according to claim 1, wherein
the liquid crystal light controller is provided on a vehicle, and
the liquid crystal light controller driving power supply includes a communication circuit that communicates with the vehicle.
